(19) United States
(12) Patent Application Publication
(10) Pub. No.: US 2025/0188203 A1
(43) Pub. Date: Jun. 12, 2025

(54) COPPER-CATALYZED AMIDATION OF POLYOLEFINS

(71) Applicants: BASF CORPORATION, Florham Park, NJ (US); THE REGENTS OF THE UNIVERSITY OF CALIFORNIA, Oakland, CA (US)

(72) Inventors: Eugen Risto, Ludwigshafen (DE); Nicodemo Robert Ciccia, San Francisco, CA (US); John F. Hartwig, Berkeley, CA (US); Martin Ernst, Ludwigshafen (DE); Carlos Lizandara Pueyo, Fremont, CA (US); Joshua C. Speros, Wyandotte, MI (US)

(21) Appl. No.: 18/848,182

(22) PCT Filed: Mar. 17, 2023
(86) PCT No.: PCT/US2023/015456

§ 371 Date: Sep. 18, 2024

Related U.S. Application Data
(60) Provisional application No. 63/321,347, filed on Mar. 18, 2022.

(51) Int. Cl. C08F 8/30; B01J 31/18

(52) U.S. Cl. CPC C08F 8/30; B01J 31/183; B01J 2231/44; B01J 2531/004; B01J 2531/16

(57) ABSTRACT

Described herein is a process for performing amidation of polyolefins including reacting a polyolefin, a copper catalyst, an amide, a ligand and an oxidant. Specifically, polyethylene may be reacting to have a degree of amide incorporation of about 0.01 mol % to about 4.75 mol % based on monomer units.

### CROSS REFERENCE TO RELATION APPLICATION(S)

The present application claims priority to U.S. Provisional Patent Application No. 63/321,347 filed on Mar. 18, 2022. The contents of which are incorporated herein in its entirety.

### FIELD OF THE INVENTION

The present invention relates generally to amidation of polyolefin. More specifically, the present invention is related to a copper catalyst for use in amidation of polyethylene.

### BACKGROUND OF THE INVENTION

Polyethylene is the most widely used commercial plastic, totaling over 150 million tons produced annually. However, the inability of chemically unmodified polyethylene to adhere to many other polymers, glues or inks necessitates composite materials and therefore greatly limits its potential for recycling or reuse. Functionalized polyethylenes containing polar groups such as esters or carboxylic acids exhibit enhanced toughness, adhesion, and printability due to intra-and intermolecular interactions enabled by the functional groups. These more versatile materials may be utilized without additives that inhibit their recycling. Despite these promising attributes, the breadth of functional polyethylenes is limited because the synthesis of these polymers is not straightforward; copolymerization of ethylene with polar vinyl comonomers is often plagued by differences in monomer reactivity ratios or poisoning of transition-metal catalysts.

Post-polymerization modification of polyethylenes is advantageous because the molecular weight distributions and the architectures of the polymers can be controlled prior to the introduction of functional groups. However, functionalization of the C—H bonds of polyethylenes without affecting the molecular weight distributions or the architectures is challenging because deleterious side reactions such as chain cleavage via β-scission or crosslinking via radical-radical coupling can occur. Thus, there is a need to develop methods to functionalize polyethylene.

In one iteration, it was found that functional materials formed by oxidation have increased adhesive properties compared to unmodified polyethylene. Despite advances in this type of polyethylene functionalization, methods to install nitrogen-containing functionality along the backbone of polyethylene remain underdeveloped.

The transformation of a C—H bond to a C—N bond in polyethylene is desired as nitrogen-containing functionality may result in materials that exhibit different properties compared to their oxo-functionalized counterparts. Additionally, amination of polyethylene would serve as a modular approach to polyolefin functionalization because various alkyl or aryl substituents can be present on nitrogen and may be used to modulate the resulting material properties. Few examples of the transformation of a C—H bond to a C—N bond in polyethylene have been reported, and these methods are limited by undesired chain cleavage, crosslinking, or limited scope. Thus, a more general method to produce amine-containing polyethylenes for a broad range of polymer architectures and a broad range of functional groups is needed.

### SUMMARY OF THE INVENTION

It has been found that reacting unmodified polyethylenes of various molecular weights and architectures with amides and di-tert-butylperoxide (DTBP) catalyzed by copper to access polyethylenes containing amide functional groups. The transformation of unmodified polyethylenes was shown to occur with virgin or waste polyethylenes to afford functionalized materials. The degree of amide incorporation into the polyethylene was varied to access functional group incorporation from 0.01 mol % to about 4.75 mol % with respect to monomer units.

In one embodiment of the present disclosure, a process for performing amidation of polyolefins is provided. The process may include reacting a polyolefin, a copper catalyst, a functional group, a ligand, and an oxidant. In an embodiment of the process, the functional group may include an amide, a carbamate, a sulfonamide, or an imide. In one embodiment of the process, the oxidant may include a peroxide.

In an embodiment of the process, the ligand may be a compound of Formula I

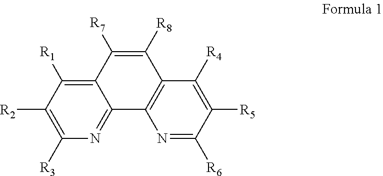

wherein,
R₁ and R₄ may each independently be, H, a C₁ to C₄ alkyl group, a halide, a C₁ to
C₄ alkoxide group or a C₁ to C₄ dialkylamino group;
R₂ and R₅ may each independently be, H, a C₁ to C₈ alkyl group, a halide, a C₁ to
C₈ alkoxide group, a C₁ to C₈ dialkylamino group or a trialkylsilyl group; and
R₃ and R₆ may each independently be, H, a C₁ to C₈ alkyl group, a halide, a C₁ to
C₈ alkoxide group or a C₁ to C₈ dialkylamino group,
R₇ and R₈ may each independently be, H, or a C₁ to C₄ alkyl group,
wherein the halide may be chloride, bromine or flouride.

In one embodiment, the ligand may be a compound of Formula I, wherein R₁ and R₄ may be H, R₂ and R₅ may be a C₁ alkyl group and R₃, R₆, R₇, and R₈ may be H. In another embodiment, the ligand may be a compound of Formula I, wherein R₁ and R₄ may be H, R₂ and R₅ may be a C₄ alkyl group and R₃, R₆, R₇, and R₈ may be H. In yet another embodiment, the ligand may be a compound of Formula I, wherein R₁ and R₄ may be H, R₂ and R₅ may be a C₈ alkyl group and R₃, R₆, R₇, and R₈ may be H.

In an embodiment of the process, the functional group may be a compound of Formulae II to VII

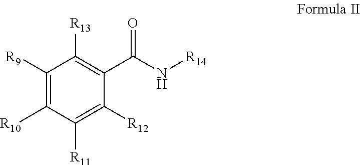

wherein R₉, R₁₀, R₁₁, R₁₂, and R₁₃ are each independently H, a C₁ to C₄ alkyl group, a C₁ to C₄ alkyl ester group, t-butyldimethylsiloxy (TBSO), a nitrile (C-triple bond N), a halide, or a C₁ to C₄ alkoxide group, wherein the halide may include chlorine, fluorine or bromide, and R₁₄ is H or a C₁ to C₄ alkyl benzamide;

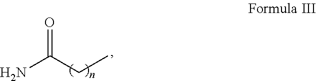

wherein, n=0 to 14;

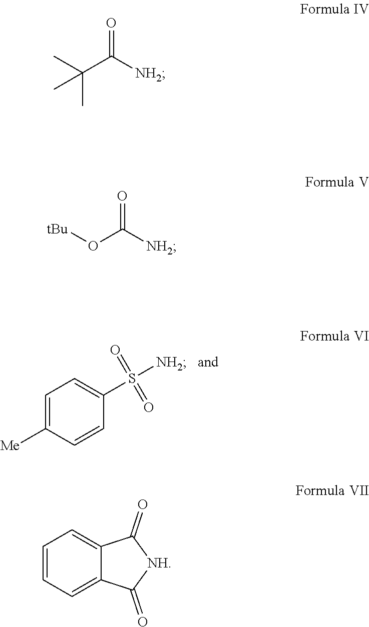

In an embodiment of the process, the functional group may be a compound of Formula II wherein R₉ to R₁₃ may be each independently H or a C₁ to C₄ alkyl group and R₁₄ is H. In another embodiment, the functional group may be a compound of Formula II wherein R₉ to R₁₁ may be each independently a C₁ to C₄ alkyl group, R₁₂ to R₁₄ may be H. In another embodiment, the functional group may be a compound of Formula II wherein R₉ to R₁₄ may be each independently H.

In an embodiment of the process, the polyolefin may include polyethylene. In another embodiment, the polyethylene may be a low-density polyethylene, linear low-density polyethylene, low molecular weight polyethylene, high-density polyethylene and high molecular weight polyethylene. In another embodiment, the polyethylene may be a low molecular weight polyethylene or a high molecular weight polyethylene.

In one embodiment of the process, the low molecular weight polyethylene may have a molecular weight from about 1 kDa to about 10 kDa, from about 2 kDa to about 9a kD, from about 3 kDa to about 8 kDa, from about 4 kDa to about 7 kDa, or from about 5 kDa to about 6 kDa.

In one embodiment of the process, the high molecular weight polyethylene may have a molecular weight from about 30 kDa to about 100 kDa, from about 35 kDa to about 90 kDa, from about 40 kDa to about 80 kDa, from about 45 kDa to about 70 kDa, from about 50 kDa to about 65 kDa, or from about 55 kDa to about 60 kDa.

In an embodiment of the process, the copper catalyst may include copper iodide CuI or CuI₂, copper chloride, such as CuCl or CuCl₂, or cupric acetate (Cu(OAc)₂).

In one embodiment of the process, the peroxide may include ditertbutyl peroxide.

In an embodiment of the process, the reacting may occur at a temperature from about 80° C. to about 120° C.

In an embodiment of the process, the reacting may occur at a temperature of about 120° C.

In an embodiment of the process, a degree of amide incorporation in the polyolefin may be about 0.01 mol % to about 4.75 mol % based on monomer units. In an embodiment of the process, a yield of the reaction may be about 5% to about 50%.

In an embodiment of the process, at least about 0.1 mol % of the catalyst may be used in the reaction. In an embodiment of the process, the process may further include dissolving the polyolefin in a solution before the reacting. In an embodiment of the process, the reacting may occur for about 30 minutes to about three hours.

In another embodiment of the present disclosure, a composition is provided. In an embodiment, the composition may include a copper catalyst, a functional group, a ligand, and an oxidant, wherein the composition includes the copper catalyst and the ligand in a 1:1 ratio. In an embodiment of the composition, the functional group may include an amide, a carbamate, a sulfonamide, or an imide.

In an embodiment of the composition, wherein the oxidant may include a peroxide. In an embodiment, the peroxide may include a tertiary alkyl peroxide, a dialkylperoxide or a peroxy ester. In another embodiment, the peroxide may include di-tert-butyl peroxide (DTBP), di-tert-amyl peroxide, cumyl peroxide, or a combination thereof.

In an embodiment of the composition, the oxide may be included in an amount of 1 mol % to about 20 mol %.

In an embodiment of the composition, the ligand may be a compound of Formula I

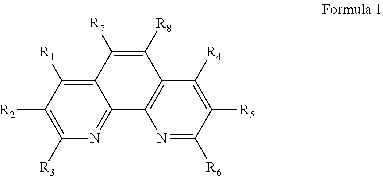

wherein,
R₁ and R₄ may each independently be, H, a C₁ to C₄ alkyl group, a halide, a C₁ to
C₄ alkoxide group or a C₁ to C₄ dialkylamino group;
R₂ and R₅ may each independently be, H, a C₁ to C₈ alkyl group, a halide, a C₁ to
C₈ alkoxide group, a C₁ to C₈ dialkylamino group or a trialkylsilyl group; and
R₃ and R₆ may each independently be, H, a C₁ to C₈ alkyl group, a halide, a Ci to
C₈ alkoxide group or a C₁ to C₈ dialkylamino group,
R₇ and R₈ may each independently be, H, or a C₁ to C₄ alkyl group,
wherein the halide may be chloride, bromine or flouride.

In an embodiment of the composition, the ligand may be a compound of Formula I, wherein R₁ and R₄ may be H, R₂ and R₅ may be a C₁ alkyl group and R₃, R₆, R₇, and R₈ may be H. In another embodiment of the composition, the ligand may be a compound of Formula I, wherein R₁ and R₄ may be H, R₂ and R₅ may be a C₄ alkyl group and R₃, R₆, R₇, and R₈ may be H. In another embodiment, the ligand may be a compound of Formula I, wherein R₁ and R₄ may be H, R₂ and R₅ may be a C₈ alkyl group and R₃, R₆, R₇, and R₈ may be H.

In an embodiment of the composition, the functional group may be a compound of Formulae II to VII

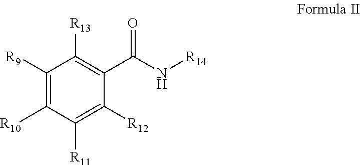

wherein R₉, R₁₀, R₁₁, R₁₂, and R₁₃ are each independently H, a C₁ to C₄ alkyl group, a C₁ to C₄ alkyl ester group, t-butyldimethylsiloxy (TBSO), a nitrile (C-triple bond N), a halide, or a C₁ to C₄ alkoxide group, wherein the halide may include chlorine, fluorine or bromide, and R₁₄ is H or a C₁ to C₄ alkyl benzamide;

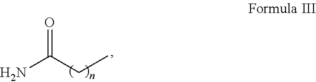

wherein, n=0 to 14;

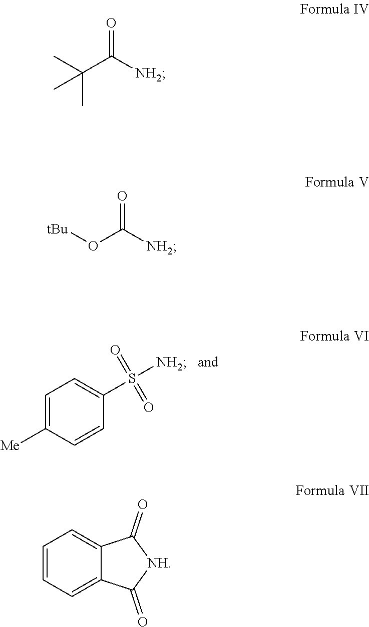

In an embodiment of the composition, the functional group may be a compound of Formula II wherein R₉ to R₁₃ may be each independently H or a C₁ to C₄ alkyl group and R₁₄ is H. In another embodiment, the functional group may be a compound of Formula II wherein R₉ to R₁₁ may be each independently a C₁ to C₄ alkyl group, R₁₂ to R₁₄ may be H. In another embodiment, the functional group may be a compound of Formula II wherein R₉ to R₁₄ may be each independently H.

In one embodiment of the composition, the copper catalyst may include copper iodide, CuI or CuI₂, copper chloride, such as CuCl or CuCl₂, or cupric acetate (Cu(OAc)₂). In an embodiment of the composition, the copper catalyst is included in an amount of about 0.1 mol % to about 1 mol %. In an embodiment of the composition, the ligand may be included in an amount of about 0.1 mol % to about 1 mol %. In an embodiment of the composition, the amide may be included in an amount of about 0.5 mol % to about 10 mol %.

### BRIEF DESCRIPTION OF THE DRAWINGS

FIG. 1 is a graph illustrating the effect of different ligands according to the present disclosure on amidation yields for low density polyethylene (LDPE) and cyclohexane.

FIG. 2 represents a range of amide incorporation as a function of amide loading in LDPE.

FIG. 3 is a ¹H NMR spectrum of a functionalized polyethylene according to an embodiment of the present disclosure.

FIGS. 4a and 4b illustrates a scope of functional groups that undergo this functionalization reaction with LDPE according to an embodiment of the present disclosure.

FIG. 5 is a photograph of an example of waste polyethylene.

### DETAILED DESCRIPTION OF THE INVENTION

The present invention advances the state of the art by developing an amidation reaction of unmodified polyolefins using a ligand, an amide and a copper catalyst. The present inventors have found that a copper complex successfully catalyzes the amidation of polyolefins with an oxidant, for example, di-tert-butyl peroxide (DTBP).

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The articles “a”, “an”, and “the” are used herein to refer to one or to more than one (i.e., to at least one) of the grammatical object of the article. By way of an example, “an element” means one element or more than one element.

The term “reaction product” or “product” means a compound which results from the reaction of the catalyst and substrate. In general, the term “reaction product” will be used herein to refer to a stable, isolable compound, and not to unstable intermediates or transition states.

The term “alkyl” refers to the radical of saturated aliphatic groups, including straight-chain alkyl groups (e.g., methyl, ethyl, propyl, butyl, pentyl hexyl, heptyl, oxtyl), branched-chain alkyl groups (e.g., i-propyl, i-butyl, t-butyl), cycloalkyl (alicyclic) groups (e.g., cyclopropyl, cyclobutyl, cyclopentyl, cyclohexyl), alkyl substituted cycloalkyl groups, and cycloalkyl substituted alkyl groups. In preferred embodiments, a straight chain or branched chain alkyl has 30 or fewer carbon atoms in its backbone (e.g., C1-C30 for straight chain, C3-C30 for branched chain), and more preferably 20 or fewer. Likewise, preferred cycloalkyls have from 4-10 carbon atoms in their ring structure, and more preferably have 5, 6 or 7 carbons in the ring structure.

The term “thiol” means —SH; and the term “hydroxyl” means —OH.

The terms “amine” and “amino” are art-recognized and refer to both unsubstituted and substituted amines.

All references to mol % throughout the specifications and the claims refer to the mole of the component in reference to the moles of C₂H₄ units when in the context of reaction with polyethylene, unless stated otherwise.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

The use of any and all examples, or exemplary language (e.g., “such as”) provided herein, is intended merely to illuminate certain materials and methods and does not pose a limitation on scope. No language in the specification should be construed as indicating any non-claimed element as essential to the practice of the disclosed materials and methods.

The present inventors have developed a series of reaction conditions known to catalyze the amidation of alkane C—H bonds for use with polyolefins, such as polyethylene.

In one embodiment of the present disclosure, a process for performing amidation of polyolefins is provided. The process for performing amidation of polyolefins may include reacting a polyolefin, a copper catalyst, a functional group, a ligand and an oxidant. The functional group may be an amide, carbamate, sulfonamide, or imide.

In one embodiment, the oxidant may include a peroxide. In another embodiment, the peroxide may be a tertiary alkyl peroxide, dialkylperoxide or peroxy ester. In some embodiments, the peroxide may include a di-tert-butyl peroxide (DTBP), di-tert-amyl peroxide, cumyl peroxide or a combination thereof.

In one embodiment, the ligand may be a compound of Formula 1

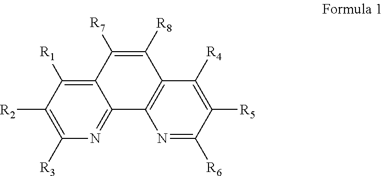

wherein,
R₁ and R₄ are each independently, H, a C₁ to C₄ alkyl group, a halide, a C₁ to C₄ alkoxide group or a C₁ to C₄ dialkylamino group;
R₂ and R₅ are each independently, H, a C₁ to C₈ alkyl group, a halide, a C₁ to C₈ alkoxide group, a C₁ to C₈ dialkylamino group or trialkylsilyl group; and
R₃ and R₆ are each independently, H, a C₁ to C₈ alkyl group, a halide, a C₁ to C₈ alkoxide group or a C₁ to C₈ dialkylamino group;
R₇ and R₈ are each independently, H, or a C₁ to C₄ alkyl group, wherein the halide may be chloride, bromine or flouride.

In another embodiment, the ligand may be a compound of Formula 1, wherein R₁ and R₄ are H; R₂ and R₅ are a C₁ alkyl group; R₃ and R₆ are H; and R₇ and R₈ are H. In yet another embodiment, the ligand may be a compound of Formula 1, wherein R₁ and R₄ are H, R₂ and R₅ are a C₄ alkyl group, R₃ and R₆ are H, and R₇ and R₈ are H. In another embodiment, the ligand may be a compound of Formula 1, wherein R₁ and R₄ are H, R₂ and R₅ are a C₈ alkyl group, R₃ and R₆ are H, and R₇ and R₈ are H. In another embodiment, the ligand may be a compound of Formula 1, wherein R₁ and R₄ are a C₁ alkoxide group, and R₂, R₃, R₅ R₆, R₇ and R₈ are H. In another embodiment, R₁ and R₄ are a C₂ dialkylamino group, and R₂, R₃, R₅ R₆, R₇ and R₈ are H. In another embodiment, R₁ and R₄ are H, R₂ and R₅ are triethylsilane, R₃ and R₆ are H, and R₇ and R₈ are H.

In one embodiment, the functional group of the process is a compound of Formulae II to VII as follows

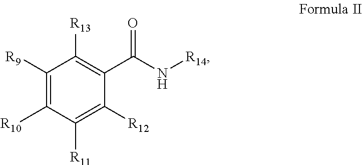

wherein R₉ to R₁₃ are each independently H, a C₁ to C₄ alkyl group, an aryl group, a heteroaryl group, a C₁ to C₄ alkyl ester group bound through O, an aryl ester group bound through O, a heteroaryl ester group bound through O, a C₁ to C₄ alkyl ester group bound through C, an aryl ester group bound through C, a heteroaryl ester group bound through C, a C₁ to C₄ alkyl carbonate, an aryl carbonate, a heteroaryl carbonate, a C₁ to C₄ N-alkyl carbamate group bound through O, a C₁ to C₄ O-alkyl C₁ to C₄ N-alkyl carbamate group bound through N, an N-aryl carbamate group bound through O, a C₁ to C₄ O-alkyl N-aryl carbamate group bound through N, an O-aryl C₁ to C₄ N-alkyl carbamate group bound through N, an O-aryl N-aryl carbamate group bound through N, an N-heteroaryl carbamate group bound through O, a C₁ to C₄ O-alkyl N-heteroaryl carbamate group bound through N, an O-heteroaryl C₁ to C₄ N-alkyl carbamate group bound through N, an O-heteroaryl N-aryl carbamate group bound through N, an O-aryl N-heteroaryl carbamate group bound through N, an O-heteroaryl N-heteroaryl carbamate group bound through N, a C₁ to C₄ N-alkyl amide group bound through C, a C₁ to C₄ alkyl C₁ to C₄ N-alkyl amide group bound through N, an N-aryl amide group bound through C, a C₁ to C₄ alkyl N-aryl amide group bound through N, an aryl C₁ to C₄ N-alkyl amide group bound through N, an aryl N-aryl amide group bound through N, an N-heteroaryl amide group bound through C, a C₁ to C₄ alkyl N-heteroaryl amide group bound through N, a heteroaryl C₁ to C₄ N-alkyl amide group bound through N, a heteroaryl N-aryl amide group bound through N, an aryl N-heteroaryl amide group bound through N, a heteroaryl N-heteroaryl amide group bound through N, a C₁ to C₄ alkyl urea, an aryl urea, a heteroaryl urea, an N-alkyl sulfonamide bound at N, an N-alkyl sulfonamide bound at S, an N-aryl sulfonamide bound at N, an N-aryl sulfonamide bound at S, an N-heteroaryl sulfonamide bound at N, an N-heteroaryl sulfonamide bound at S, a vinyl group, a propargyl group, a C₁ to C₄ a trialkylsiloxy group, a nitrile (NC—), a halide, a C₁ to C₄ alkoxide group, or a C₁ to C₄ dialkyl amine, wherein the halide may include chlorine, fluorine or bromide, and R₁₄ is a H or C₁ to C₄ alkyl benzamide;

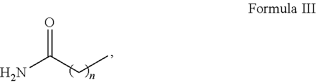

wherein, n=0 to _{14, 0} to _{12, 0} to _{10, 0} to 8, 0 to 6, 0 to 4 or 0 to 2, or alternatively, wherein n=0, 2, 4, or 6;

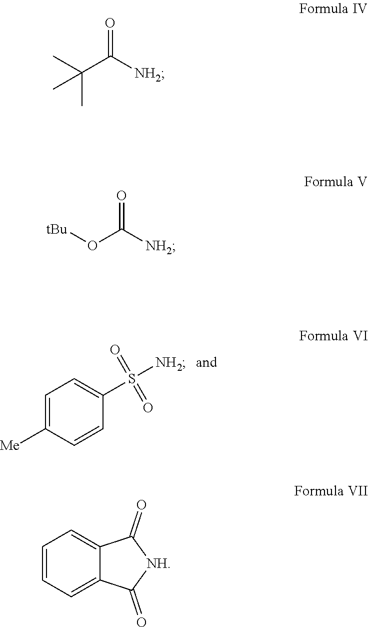

In some embodiments of the process, the functional group may be a compound of Formula II, wherein R₉, to R₁₃ are each independently H, a C₁ to C₄ alkyl group, a C₁ to C₄ alkyl ester group, t-butyldimethylsiloxy (TBSO), a nitrile (C-triple bond N), a halide, or a C₁ to C₄ alkoxide group, wherein the halide may include chlorine, fluorine or bromide, and R₁₄ is H or a C₁ to C₄ alkyl benzamide.

In another embodiment of the process, the functional group may be a compound of Formula II wherein R₉ to R₁₃ may be each independently H or a C₁ to C₄ alkyl group and R₁₄ is H. In another embodiment, the functional group may be a compound of Formula II wherein R₉ to R₁₄ may be each independently a C₁ to C₄ alkyl group, R₁₂ to R₁₄ may be H. In another embodiment, the functional group may be a compound of Formula II wherein R₉ to R₁₄ may be each independently H

In some embodiments, the polyolefin of the process includes polyethylene.

In an embodiment of the process, when the polyolefin includes polyethylene, the polyethylene may be a low-density polyethylene, linear low-density polyethylene, low molecular weight polyethylene, high-density polyethylene, and high molecular weight polyethylene. In another embodiment of the process, the polyethylene may be medium-density polyethylene, very low density polyethylene, chlorinated polyethylene, metallocene polyethylene, or Fischer-Tropsch wax. In another embodiment, the polyethylene may be a low molecular weight polyethylene or a high molecular weight polyethylene. The low molecular weight polyethylene has a molecular weight from about 1 kDa to about 10 kDa, from about 2 kDa to about 9 kDa, from about 3 kDa to about 8 kDa, from about 4 kDa to about 7 kDa, or from about 5 kDa to about 6 kDa, or any sub-range within. The high molecular weight polyethylene has a molecular weight from about 30 kDa to about 100 kDa, from about 35 kDa to about 90 kDa, from about 40 kDa to about 80 kDa, from about 45 kDa to about 70 kDa, from about 50 kDa to about 65 kDa, or from about 55 kDa to about 60 kDa, or any sub-range within.

In an embodiment of the process, the copper catalyst may include copper iodide, such as CuI or CuI₂, copper chloride, such as CuCl or CuCl₂, or cupric acetate (Cu(OAc)₂).In an embodiment of the process, the reaction occurs at a temperature from about 80° C. to about 120° C., from about 90° C. to about 110° C., from about 95° C. to about 105° C., or at about 80° C., at about 85° C., at about 90° C., at about 95° C., at about 100° C., at about 105° C., at about 110° C., at about 115° C. or at about 120° C. In another embodiment of the process, the reaction occurs at a temperature from about 80° C. to about 220° C., from about 90° C. to about 210° C., from about 100° C. to about 200° C., from about 110° C. to about 190° C., from about 120° C. to about 180° C., from about 130° C. to about 170° C., from about 140° C. to about 160° C., or from about 145° C. to about 155° C. When the reaction occurs at a higher temperature, it is to be understood that the reaction occurs in melt form.

The ability to selectively target various degrees of functional group incorporation is crucial to tune the material properties of functional polyethylenes for specific applications. In one embodiment of the process, a degree of amide incorporation in the polyolefin is from about 0.01 mol % to about 4.75 mol %, from about 0.1 mol % to about 4.75 mol %, from about 0.5 mol % to about 4.25 mol %, from about 1 mol % to about 4 mol %, from about 1.25 mol % to about 3.75 mol %, from about 1.5 mol % to about 3.5 mol %, from about 1.75 mol % to about 3.25 mol %, from about 2 mol % to about 3 mol %, or from about 2.25 mol % to about 2.75 mol % based on monomer units, or any sub-ranges not listed herein.

In a particular embodiment, low-density polyethylene may be used in the process. Low-density polyethylene is prevalently used in commercial applications and has increased solubility in organic solvents compared to polyethylenes with lower degrees of branching. There are many challenges associated with the functionalization of polyethylene, which requires high temperatures and non-polar solvents that are incompatible with many existing methods. It was surprisingly found that a copper complex successfully catalyzed the amidation of polyethylene with DTBP as an oxidant. Further modification of reaction conditions was required to achieve high yields for the amidation of polyethylene that were comparable to the yields observed for the amidation of small alkanes.

In another embodiment of the present disclosure, a composition is provided. The composition may include a copper catalyst, a functional group, a ligand, and an oxidant, wherein the composition may include a ratio of the copper catalyst to the ligand is 1:1. The functional group may include an amide, carbamate, sulfonamide, or imide.

In an embodiment of the composition, the oxidant may include a peroxide. In one embodiment, the peroxide may include a tertiary alkyl peroxide, a dialkylperoxide, or a peroxy ester. In another embodiment, the peroxide may include di-tert-butyl peroxide (DTBP), di-tert-amyl peroxide, cumyl peroxide, or a combination thereof.

In one embodiment, the composition may include an oxidant in an amount of 1 mol % to about 20 mol %.

In an embodiment, the composition may include a ligand being a compound of Formula I

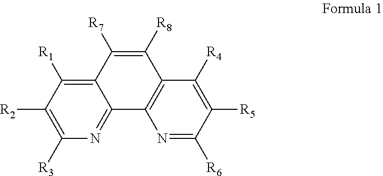

wherein,
R₁ and R₄ are each independently, H, a C₁ to C₄ alkyl group, a halide, a C₁ to C₄ alkoxide group or a C₁ to C₄ dialkylamino group;
R₂ and R₅ are each independently, H, a C₁ to C₈ alkyl group, a halide, a C₁ to C₈ alkoxide group, a C₁ to C₈ dialkylamino group or trialkylsilyl group; and
R₃ and R₆ are each independently, H, a Ci to Cs alkyl group, a halide, a C₁ to C₈ alkoxide group or a C₁ to C₈ dialkylamino group,
R₇ and R₈ are each independently, H, or a C₁ to C₄ alkyl group,
   wherein the halide may be chloride, bromine or flouride.

In one embodiment of the ligand, R₁ and R₄ may be H, R₂ and R₅ are a C₁ alkyl group and R₃, R₆, R₇, and R₈ may be H. In another embodiment of the ligand, R₁ and R₄ may be H, R₂ and R₅ are a C₁ alkyl group and R₃, R₆, R₇, and R₈ may be H. In another embodiment of the ligand, R₁ and R₄ may be H, R₂ and R₅ may be a C₄ alkyl group and R₃, R₆, R₇, and R₈ may be H. In yet another embodiment of the ligand, R₁ and R₄ are H, R₂ and R₅ may be a C₈ alkyl group and R₃, R₆, R₇, and R₈ may be H.

In one embodiment of the composition, the functional group may be a compound of Formulae II to VII

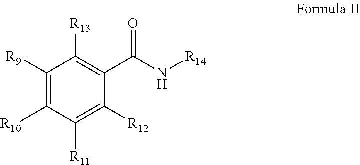

wherein R₉ to R₁₃ are each independently H, a C₁ to C₄ alkyl group, an aryl group, a heteroaryl group, a C₁ to C₄ alkyl ester group bound through O, an aryl ester group bound through O, a heteroaryl ester group bound through O, a C₁ to C₄ alkyl ester group bound through C, an aryl ester group bound through C, a heteroaryl ester group bound through C, a C₁ to C₄ alkyl carbonate, an aryl carbonate, a heteroaryl carbonate, a C₁ to C₄ N-alkyl carbamate group bound through O, a C₁ to C₄ O-alkyl C₁ to C₄ N-alkyl carbamate group bound through N, an N-aryl carbamate group bound through O, a C₁ to C₄ O-alkyl N-aryl carbamate group bound through N, an O-aryl C₁ to C₄ N-alkyl carbamate group bound through N, an O-aryl N-aryl carbamate group bound through N, an N-heteroaryl carbamate group bound through O, a C₁ to C₄ O-alkyl N-heteroaryl carbamate group bound through N, an O-heteroaryl C₁ to C₄ N-alkyl carbamate group bound through N, an O-heteroaryl N-aryl carbamate group bound through N, an O-aryl N-heteroaryl carbamate group bound through N, an O-heteroaryl N-heteroaryl carbamate group bound through N, a C₁ to C₄ N-alkyl amide group bound through C, a C₁ to C₄ alkyl C₁ to C₄ N-alkyl amide group bound through N, an N-aryl amide group bound through C, a C₁ to C₄ alkyl N-aryl amide group bound through N, an aryl C₁ to C₄ N-alkyl amide group bound through N, an aryl N-aryl amide group bound through N, an N-heteroaryl amide group bound through C, a C₁ to C₄ alkyl N-heteroaryl amide group bound through N, a heteroaryl C₁ to C₄ N-alkyl amide group bound through N, a heteroaryl N-aryl amide group bound through N, an aryl N-heteroaryl amide group bound through N, a heteroaryl N-heteroaryl amide group bound through N, a C₁ to C₄ alkyl urea, an aryl urea, a heteroaryl urea, an N-alkyl sulfonamide bound at N, an N-alkyl sulfonamide bound at S, an N-aryl sulfonamide bound at N, an N-aryl sulfonamide bound at S, an N-heteroaryl sulfonamide bound at N, an N-heteroaryl sulfonamide bound at S, a vinyl group, a propargyl group, a C₁ to C₄ a trialkylsiloxy group, a nitrile (NC—), a halide, a C₁ to C₄ alkoxide group, or a C₁ to C₄ dialkyl amine, wherein the halide may include chlorine, fluorine or bromide, and R₁₄ is a H or C₁ to C₄ alkyl benzamide;

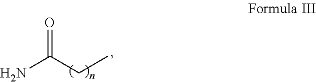

wherein, n=0 to 14, 0 to 12, 0 to 10, 0 to 8, 0 to 6, 0 to 4 or 0 to 2, or alternatively, wherein n=0, 2, 4, or 6;

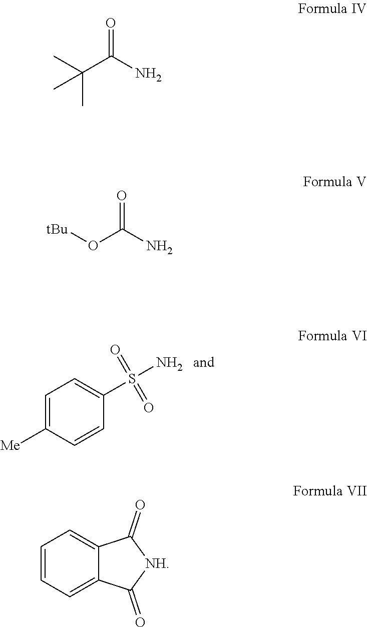

In an embodiment of the functional group, the functional group may be a compound of Formula II, wherein R₉ to R₁₃ may each independently be H, a C₁ to C₄ alkyl group, a C₁ to C₄ alkyl ester group, t-butyldimethylsiloxy (TBSO), a nitrile (C-triple bond N), a halide, or a C₁ to C₄ alkoxide group, wherein the halide may include chlorine, fluorine or bromide, and R₁₄ is H or a C₁ to C₄ alkyl benzamide.

In another embodiment of the functional group, the functional group may be a compound of Formula II wherein R₉ to R₁₃ may be each independently H or a C₁ to C₄ alkyl group and R₁₄ is H. In another embodiment, the functional group may be a compound of Formula II wherein R₉ to R₁₁ may be each independently a C₁ to C₄ alkyl group, R₁₂ to R₁₄ may be H. In another embodiment, the functional group may be a compound of Formula II wherein R₉ to R₁₄ may be each independently H.

In an embodiment of the composition, the copper catalyst may be copper iodide, CuI or CuI₂, copper chloride, such as CuCl or CuCl₂, or cupric acetate (Cu(OAc)₂). The copper catalyst may be included in an amount of about 0.1 mol % to about 1 mol %. In an embodiment of the composition, the ligand may be included in an amount of about 0.1 mol % to about 1 mol %. In another embodiment of the composition, the amide may be included in an amount of about 0.5 mol % to about 10 mol %.

### EXAMPLES

Specific embodiments of the invention will now be demonstrated by reference to the following examples. It should be understood that these examples are disclosed solely by way of illustrating the invention and should not be taken in any way to limit the scope of the present invention.

### Amidation of Polyethylene

Amidation of low density of polyethylene (LDPE) was performed using benzamide as the amide in combination with various ligands. It was found that both concentration and ligand identity played crucial roles in achieving high degrees of functional group incorporation without cleavage or crosslinking of the polymer chains.

Reactions were performed with low molecular weight LDPE and high molecular weight LDPE. For reaction with low molecular weight LDPE (Mw=2.38 kDa), a reaction mixture containing 3.58 M (100 mg/mL) LDPE resulted in low yields of amidation, whereas higher concentrations of LDPE (8.95 M (250 mg/mL)-17.9 M (500 mg/mL)) yielded greater degrees of amide incorporation. However, at a higher polymer concentration of 35.8 M (1000 mg/mL), lower yields were observed. Without being limited to a theory, the inventors believe that the lower yields are likely due to insolubility of benzamide at this concentration. Thus, at higher concentrations of about 17.9 M to 35.8 M, the reaction mixtures were prone to solidification at extended times, presumably due to crosslinking of polymer chains via radical-radical coupling. The resulting solids were insoluble in both 1,1,2,2-tetrachloroethane and 1,2,4-trichlorobenze at 130° C. and thus were unable to be characterized by high-temperature NMR spectroscopy or gel-permeation chromatography (GPC). For reaction with high molecular weight LDPE (Mw=35.1 kDa), similar trends were observed. Specifically, an increase of polymer concentration from 3.58 M to 8.95 M resulted in an increase in the yield of amidation from 6.50% to 23.5% (Table 1, Entries 9 and 11). However, reaction with higher molecular weight LDPE was more prone to solidification at these concentrations than the lower molecular weight LDPE (Table 1, Entries 10 and 12). Thus, reaction times were limited to 90 minutes to maximize yields without producing a crosslinked material.

TABLE 1
Effect of concentration on the yield of C-H amidation of LDPEs.^{a}

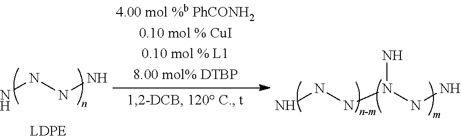

| | Concentration^{c} | Time | Yield^{d} | m | Mn^{oe,f} | | | |
|---|---|---|---|---|---|---|---|---|
| Reaction | (M) | (h) | (%) | (mol %)^{b} | (kDa) | Ð^{g} | Mₙ (kDa) | Ð |
| 1 | 3.58 | 1.5 | 10.5 | 0.42 | 2.38 | 3.3 | 3.24 | 2.5 |
| 2 | 3.58 | 24 | 17.3 | 0.69 | 2.38 | 3.3 | 3.34 | 3.3 |
| 3 | 8.95 | 1.5 | 32.3 | 1.29 | 2.38 | 3.3 | 3.25 | 2.6 |
| 4 | 8.95 | 24 | 43.0 | 1.72 | 2.38 | 3.3 | 2.98 | 3.7 |
| 5 | 17.9 | 1.5 | 44.3 | 1.77 | 2.38 | 3.3 | 2.84 | 3.0 |
| 6 | 17.9 | 24 | — | — | 2.38 | 3.3 | — | — |
| 7 | 35.8 | 1.5 | 36.0 | 1.44 | 2.38 | 3.3 | 3.71 | 2.2 |
| 8 | 35.8 | 24 | — | — | 2.38 | 3.3 | — | — |
| 9 | 3.58 | 1.5 | 6.50 | 0.26 | 35.1 | 6.5 | 22.4 | 3.6 |
| 10 | 3.58 | 24 | — | — | 35.1 | 6.5 | — | — |
| 11 | 8.95 | 1.5 | 23.5 | 0.94 | 35.1 | 6.5 | 24.5 | 4.7 |
| 12 | 8.95 | 2.0 | — | — | 35.1 | 6.5 | — | — |

^{a}: Conditions: 17.9 mmol of LDPE, 0.714 mmol of benzamide, 0.0179 mmol of Cul, 0.0178 mmol of L1, 1.44 mmol of DTBP, 1,2-DCB at 120° C.
^{b}: Mol % relative to monomer unit.
^{c}: Concentration of C2H4 units.
^{d}: Yield = [m]/[PhCONH2].
e: Initial Mn of the starting unmodified polyethylene.
^{f}: Mn relative to polystyrene standard.
^{g}: Initial Ð of the starting unmodified polyethylene.
^{h}:Solidification occurred. The resulting solids were insoluble and unable to be characterized by 1H NMR spectroscopy or GPC chromatography.

TABLE 2
Phenanthroline Derivatives

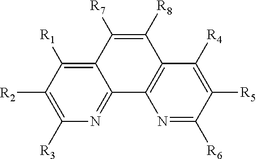

| Ligand | R₁ | R₂ | R₃ | R₄ | R₅ | R₆ | R₇ | R₈ |
|---|---|---|---|---|---|---|---|---|
| L1 | H | H | H | H | H | H | H | H |
| L2 | OMe | H | H | OMe | H | H | H | H |
| L3 | H | H | Me | H | H | Me | H | H |
| L4 | H | Me | H | H | Me | H | H | H |
| L5 | Me | Me | H | Me | Me | H | H | H |
| L6 | H | H | H | H | H | H | Me | Me |
| L7 | H | nBu | H | H | nBu | H | H | H |
| L8 | H | n(C₈H₁₇) | H | H | n(C₈H₁₇) | H | H | H |

Amidation reactions of small alkanes catalyzed by copper(I) and 1,10-phenanthroline (L1) or by copper(I) and 4,7-dimethoxy-1,10-phenanthroline (L2) occurred in high yields. (Tran, B. L.; Li, B. J.; Driess, M.; Hartwig, J. F., Copper-Catalyzed Intermolecular Amidation and Imidation of Unactivated Alkanes. J. Am. Chem. Soc. 2014, 136, 2555-2563.) However reactions catalyzed by the same systems with LDPE resulted in suboptimal functional group incorporation (Table 3, Entries 1-2). Additionally, a significant decrease in molecular weight was observed for the resulting polymers. Based on our observation of cleavage of the polyethylene chains accompanying low yields, the inventors hypothesized that combination of the alkyl radical, generated by C-H abstraction from an alkoxy radical, with a putative copper(II) amidate species was slower than β-scission.

An experiment was conducted to investigate the effect of various ligands on the degree of functional group incorporation and the molecular weight of the resulting functional polyethylenes. Reaction with other ligand scaffolds, such as bipyridine and diimine compounds, resulted in no functional-group incorporation. A reaction with a series of phenanthroline derivatives containing alkyl substituents (Table 2) was also investigated. Previous work on the design of polymerization catalysts utilized solubilizing alkyl chains on the ligand to access materials with high molecular weights. (Matyjaszewski, K.; Patten, T. E.; Xia, J., Controlled/“Living” Radical Polymerization. Kinetics of the Homogeneous Atom Transfer Radical Polymerization of Styrene. J. Am. Chem. Soc. 1997, 119, 674-680.; Haddleton, D. M.; Crossman, M. C.; Dana, B. H.; Duncalf, D. J.; Heming, A. M.; Kukulj, D.; Shooter, A. J., Atom Transfer Polymerization of Methyl Methacrylate Mediated by Alkylpyridylmethanimine Type Ligands, Copper(I) Bromide, and Alkyl Halides in Hydrocarbon Solution. Macromolecules 1999, 32, 2110-2119.) While employed in polymerization reactions, this strategy of incorporating solubilizing alkyl substituents on the ligand backbone has been unexplored for the post-polymerization functionalization of polyolefins. Without being limited to theory, the inventors hypothesized that such effects may improve the yield of amidation given the incompatibility of polyethylenes with polar compounds. As can be seen in Table 3, reactions with phenanthroline derivatives that contain alkyl substituents at the 3 and 8 positions (L4, L7-L8) exhibited higher yields than their unsubstituted counterpart (Table 2, Entries 1, 4, 7-8). Specifically, the yields of amide incorporation were 23.5%, 25.5%, 29.8%, and 45.0% with R2=H (L1), Me (L4), nBu (L7), and n(C₈H₁₇) (L8), respectively. In addition to an increase in yield, reaction with L8 occurred with minimal observed chain-cleavage (Mn=32.4), whereas a greater decrease in molecular weight of the polyethylene was observed upon reaction with L1, L4, and L7 (Mn=24.5 kDa, 29.0 kDa, and 27.2 kDa, respectively). These observations suggest that the alkyl substitution on the ligand accelerates combination of the polymeric alkyl radical with the copper (II) amidate and limits side reactivity of the alkyl radical. A similar trend for the effect of ligand substitution patterns on the yield of amidation was observed for lower molecular weight polyethylene (Table 3, Entries 9-11).

TABLE 3
Effect of Ligand on the Yield of Amidation^{a}

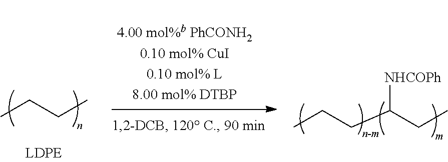

| | | Yield^{c} | m | Mn^{cd,e} | | Mn | |
|---|---|---|---|---|---|---|---|
| Entry | Ligand | (%) | (mol %)^{b} | (kDa) | Ð^{f} | (kDa) | Ð |
| 1 | L1 | 23.5 | 0.94 | 35.1 | 6.5 | 24.5 | 4.7 |
| 2 | L2 | 22.8 | 0.91 | 35.1 | 6.5 | 24.7 | 12.1 |
| 3 | L3^{g} | 3.00 | 0.12 | 35.1 | 6.5 | 27.5 | 5.1 |
| 4 | L4 | 25.5 | 1.02 | 35.1 | 6.5 | 29.0 | 10.2 |
| 5 | L5^{h} | 8.75 | 0.35 | 35.1 | 6.5 | 18.9 | 11.9 |
| 6 | L6 | 18.0 | 0.72 | 35.1 | 6.5 | 20.5 | 10.0 |
| 7 | L7 | 29.8 | 1.19 | 35.1 | 6.5 | 27.2 | 10.6 |
| 8 | L8 | 45.0 | 1.80 | 35.1 | 6.5 | 32.4 | 7.2 |
| 9 | L1ⁱ | 34.8 | 1.39 | 2.38 | 3.3 | 2.82 | 3.0 |
| 10 | L7ⁱ | 42.5 | 1.7 | 2.38 | 3.3 | X | X |
| 11 | L8ⁱ | 45.0 | 1.80 | 2.38 | 3.3 | 3.06 | 3.0 |

^{a}: Conditions: 17.9 mmol of LDPE, 0.714 mmol of benzamide, 0.0179 mmol of CuI, 0.0178 mmol of Ligand, 1.44 mmol of DTBP, 2mL of 1,2-DCB at 120° C.
^{b}: Mol % relative to monomer unit.
^{c}: Yield = [m]/[PhCONH2].
^{d}: Initial Mn of the starting unmodified polyethylene.
^{e}. Mn relative to polystyrene standard.
^{f}: Initial Ð of the starting unmodified polyethylene.
^{g}: Reaction time of 60 minutes.
^{h}: Reaction time of 50 minutes.
ⁱ:solvent volume of 1.0 mL 1,2-DCB.

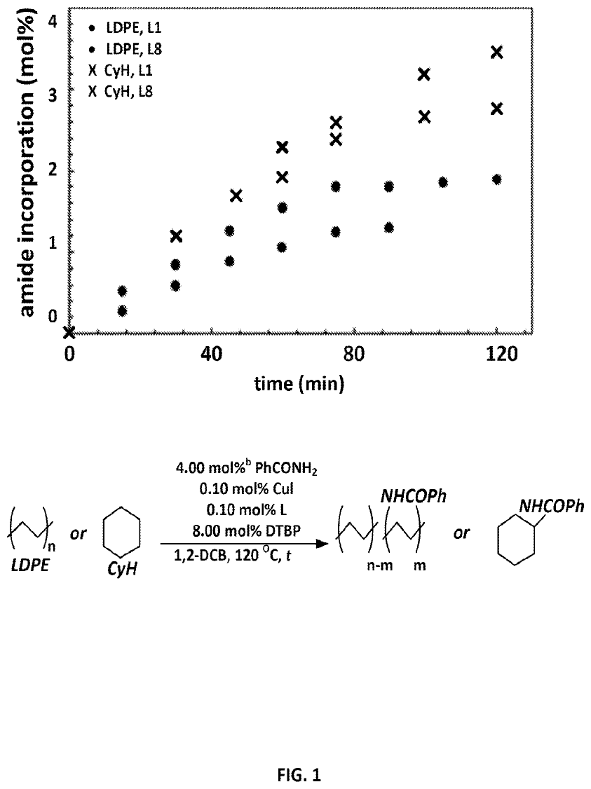

To further understand the origin of the ligand effect, the amidation of polyethylenes with L1 and L8 was compared to the amidation of small alkanes with L1 and L8. To ensure accurate comparisons, the equivalents of reagents for reactions with small alkanes were fixed relative to C₂H₄ units so that the concentration of C—H bonds was equal in all cases. Throughout the entire course of the reaction with polyethylene (Mn=35.1 kDa), functional group incorporation was higher with L8 than with L1, which can be seen in FIG. 1. In FIG. 1, the effect of ligand amidation yields for LDPE and cyclohexane over time were observed. The reaction was conducted under the following conditions: 17.9 mmol of LDPE or 5.95 mmol cyclohexane, 0.714 mmol of benzamide, 0.0179 mmol of CuI, 0.0178 mmol of ligand, 1.44 mmol of DTBP, 2 mL or 1 mL of 1,2-dichlorobenzene (1,2-DCB) at 120° C. The reaction of LDPE with L1 solidified after 90 minutes.

This trend was also observed for reaction with low molecular weight LDPE (Mn=2.38 kDa). However, this trend was not observed for cyclohexane. For the reaction of cyclohexane, amidation occurred with about the same initial rates for both L1 and L8, and higher yields were ultimately observed with L1. These data show that the relative rates of elementary steps on and off the catalytic cycle depend on the molecular weight of the alkane, possible resulting from differences in the rates of substrate or catalyst diffusion. The observation that ligands with aliphatic substituents positively impact the yields for the functionalization of polyethylenes may prove advantageous in future development of other catalytic modifications of polyolefins.

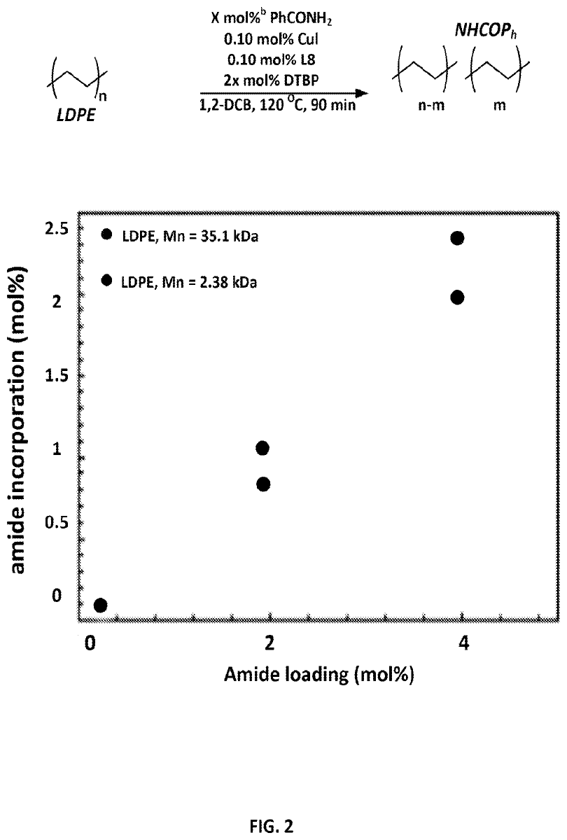

It has been found that functional polyethylenes with amide incorporation between 0.1 mol % to 4.75 mol % can be accessed with C—H amidation. The present inventors have found that there is a linear dependence of the degree of amide incorporation on the amide loading. As can be seen in FIG. 2, the degree of amide incorporation with respect to amide loading is illustrated. As shown in the plot, reaction of high molecular weight LDPE (Mn=35.1 kDa) with amide loadings from 0.25% to 4.00% give functional polyethylenes with amide incorporations from 0.07% to 1.83%. This linear relationship between amide loading and amide incorporation for reaction with high molecular weight LDPE exhibits an R² value of 1.00. Reaction of low molecular weight LDPE (Mn=2.38 kDa) with amide loadings from 0.25% to 4.00% give functional polyethylenes with amide incorporations from 0.10% to 2.30%. This linear relationship between amide loading and amide incorporation for reaction with low molecular weight LDPE exhibits an R² value of 1.00. The reaction of FIG. 2 was conducted under the following conditions: 17.9 mmol of LDPE, 0.179, 0.357, or 0.714 mmol of benzamide, 0.0179 mmol of CuI, 0.0178 mmol of L8, 1.44 mmol of DTBP, 2 mL or 1 mL of 1,2-DCB at 120° C. for 90 minutes.

### Selectivity of C—H Amidation of Polyethylene

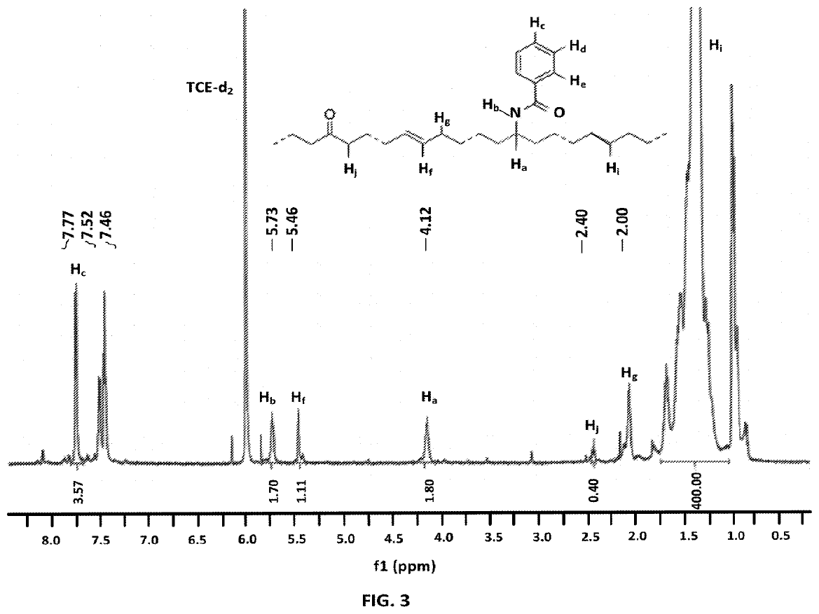

Upon reaction with benzamide, the resulting functional polyethylenes were characterized by both variable temperature ¹H NMR spectroscopy at 100° C. and IR spectroscopy to determine the selectivity of functional group formation. As illustrated in FIG. 3, the degree of amide incorporation was determined by the integration of the methikne proton a to the amide group (Hₐ), which resonates at 4.13 ppm, relative to the integration of peaks between 1.4 and 1.0 ppm (Hᵢ) that were set to total the four protons per unmodified C₂H₄ unit. Considering the high degree of branching in LDPE, it was also sought to determine the selectivity of this amidation for the primary, secondary or tertiary C—H bonds of polyethylene. The ratios of integrations of the aromatic protons H_{c}, which resonate at 7.76 ppm, to the integration of methine proton Hₐ were used to determine this selectivity. It was found that there was a precise 2:1 ratio of the integrations of these protons; thus, it is theorized that this transformation is selective for the secondary C—H bonds along the polyethylene chain; a ratio greater than 2:1 would indicate a higher selectivity for tertiary C—H bonds whereas a ratio less than 2:1 would indicate a higher selectivity for primary C—H bonds.

In all cases for the C—H amidation of LDPE, the formation of minor amounts of internal olefin and ketone groups was observed. As illustrated in FIG. 3, the degree of olefin incorporation was determined by the integration of the vinyl protons (H_{f}), which resonate at 5.38 ppm, relative to the integration of peaks between 1.4 and 1.0 ppm (Hᵢ) that were set to total the four protons per unmodified C—H unit. The degree of ketone incorporation was determined by the integration of methylene protons a to the ketone units (Hⱼ), which resonate at 3.40 ppm, relative to the integration of peaks corresponding to Hᵢ. Reaction of different molecular weight LDPEs with 4.00% amide loaded showed that reaction with low molecular weight LDPE (Mn=2.38 kDa) resulted in 0.92% internal olefin incorporation and 0.02% ketone incorporation, and reaction with high molecular weight LDPE (Mn=35.1 kDa) resulted in 0.56% internal olefin incorporation and 0.10% ketone incorporation. Control experiments with both LDPE and octadecane in the absence of either amide, copper, and/or DTBP indicate that internal olefin may be generated via dehydrogenation upon reaction of alkane and peroxide, catalyzed by copper. Similar copper catalysts have been shown to catalyze the dehydrogenation of alkanes through a radical pathway (Conde, A. et al, “Introducing Copper as Catalyst for Oxidative Alkane Dehydrogenation,” J. Am. Chem. Soc. 2013, 135, 3887-3896). These control experiments also indicated that ketone groups were generated upon an uncatalyzed reaction between the alkane and DTBP. While similar copper-based systems have been shown to undergo C—H etherification of alkanes, the formation of ketones occurs in similar yields with and without copper. The formation of ketone groups was also observed in the absence of oxygen, which supports that the minor amounts of ketone groups are generated by reaction of alkane with peroxide.

### Scope of C—H Amidation of Polyethylenes

The scope of polyethylenes with varying molecular weights and architectures that undergo this C—H amidation reaction with benzamide is summarized in Table 4. All polyethylene functionalization reactions employ 4.00% amide loading relative to C₂H₄ units. As described above, low molecular weight LDPE (Mn=2.38 kDa) underwent functionalization in 45.0% yield to achieve amide incorporation of 1.80 mol % and amidation of high molecular weight LDPE (Mn=35.1 kDa) also occurred in 45% yield and 1.80 amide incorporation. High-density polyethylene (HDPE) and linear low-density polyethylene (LLDPE) both required decreased concentration for functionalization to occur without solidification. With these modified conditions, however, both HDPE and LLDPE underwent C—H amidation to give functional polyethylenes with 0.37% and 0.20% amide incorporation, respectively.

TABLE 4
Scope of polyethylenes^{a}

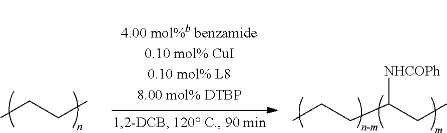

| | | Yield^{c} | | Mn^{od,e} | | MI | |
|---|---|---|---|---|---|---|---|
| Entry | Polymer | (%) | (mol %)^{b} | (kDa) | Ð^{f} | (kDa) | Ð |
| 1 | LDPE | 45.0 | 1.80 | 2.38 | 3.3 | 3.06 | 3.0 |
| 2ª | LDPE | 45.0 | 1.80 | 35.1 | 6.5 | 32.4 | 7.2 |
| 3^{h} | HDPE | 9.3 | 0.37 | X | X | X | X |
| 4ⁱ | LLDPE | 5.0 | 0.20 | X | X | X | X |
| 5 | Waste LDPE | 9.5 | 0.38 | X | X | X | X |

^{a}: Conditions: 17.9 mmol of LDPE, 0.714 mmol of benzamide, 0.0179 mmol of Cul, 0.0178 mmol of L8, 1.44 mmol ofDTBP, 1 mL of 1,2-DCB at 120° C.
^{b}: Mol % relative to monomer unit.
^{c}: Yield = [m]/[PhCONH2].
^{d}: Initial Mn of the starting unmodified polyethylene.
^{e}: Mn relative to polystyrene standard.
^{f}: Initial D of the starting unmodified polyethylene.
^{g}: solvent volume of 2.0 mL 1,2-DCB.
^{h}: solvent volume of 6.0 mL 1,2-DCB.
ⁱ: solvent volume of 7.0 mL 1,2-DCB.

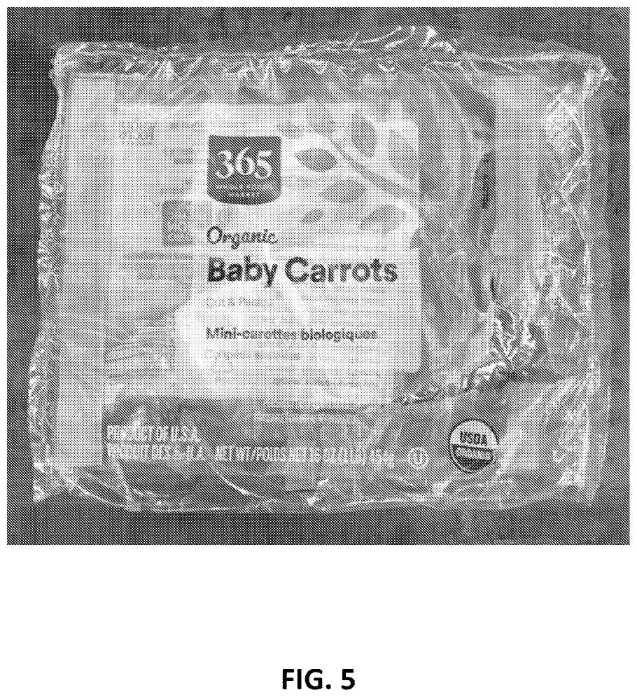

The C-H amidation of waste polyethylene materials was also studied. (FIG. 5). Catalytic functionalization of post-consumer polyethylenes was more challenging than the functionalization of virgin materials because post-consumer materials often contain dyes, plasticizers, or even consumer waste that can inhibit reactivity by poisoning transition-metal catalysts. However, successfully functionalization of contaminated post-consumer polyethylenes is crucial to viably upcycle these materials for subsequent applications. Reaction of post-consumer polyethylene with benzamide gave a functionalized material with amide incorporations of 0.38%. These upcycled materials have comparable degrees of amide incorporation to the functional materials resulting from amidation of virgin polyethylenes (Table 4, Entries 3-4), demonstrating the applicability of this polyolefin functionalization.

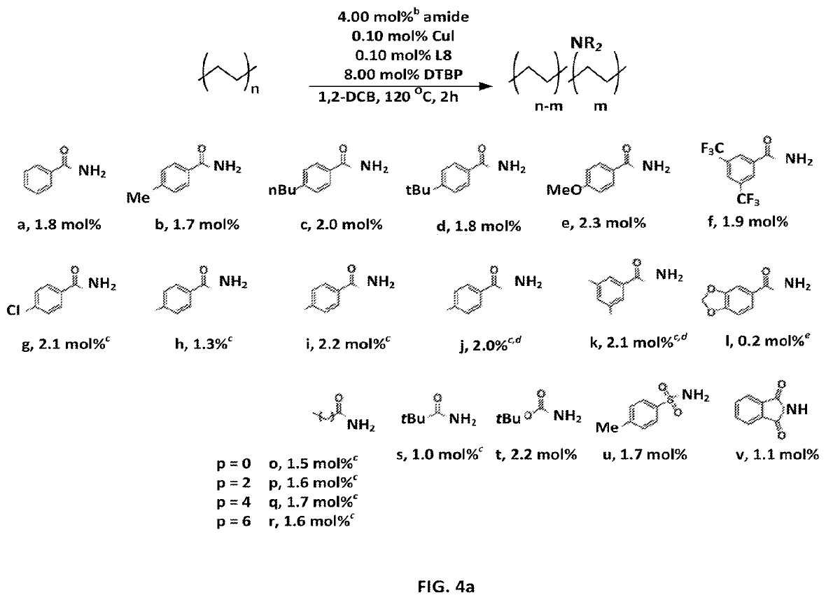

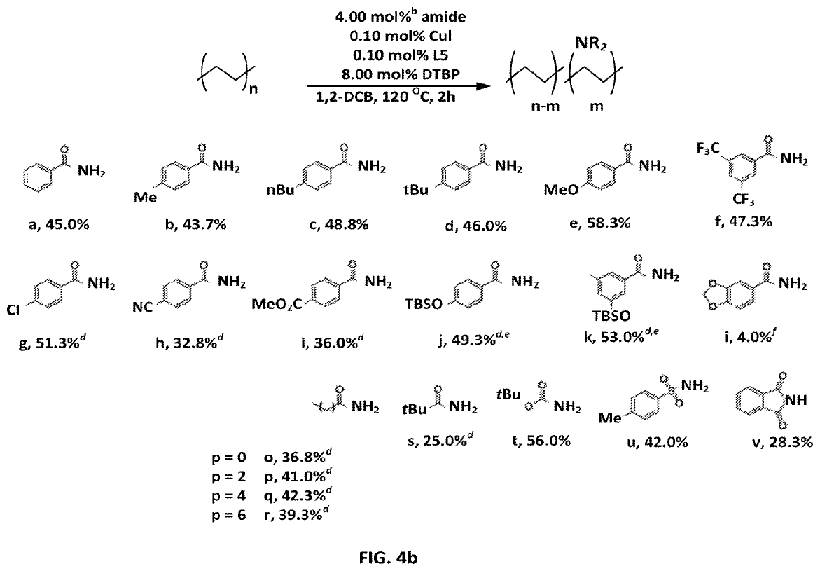

Functionalization reactions of LDPE with various functional groups are illustrated in FIGS. 4a and 4b. FIGS. 4a and 4b includes the amount of amide incorporation that occurs during the reaction. Benzamides with electron-donating groups, such as Me, nBu, tBu and OMe, underwent the reaction to give functional polyethylenes with good amide incorporation. Electron-withdrawing groups, such as Cl, CF₃, and CN were also tolerated to produce functional polyethylenes with amide incorporation between 1.31%-2.05%. Reactions of benzamides with CN, CO₂Me, and OTBS groups were particularly notable because the resulting functional LDPEs were further derivatized to reveal pendant amine, carboxylic acid and alcohol groups that affect the properties of the materials. Other amides, such as p-toluenesulfonamide, phthalimide, and alkylamides were also found to react with LDPE to give functional-group incorporations between 1.00%-1.69%. Reaction with tert-butyl carbamate afforded functional LDPE with 2.2% carbamate incorporation. This carbamate group was readily converted to both the free amine and the ammonium salt upon treatment with either trifluoroacetic acid (TFA) or HCl to furnish a polyethylene material with low percentages of pendant primary amines along the polymer backbone. Reactions with benzamide and tert-butyl carbamate were also performed on a decagram scale with no reduction in yield or amide incorporation compared to the reaction on a milligram scale.

### Determination of Material Properties of Functionalized Polyethylenes

Further tests are being developed to determine the material properties of functionalized polyethylenes.

While certain embodiments have been illustrated and described, it should be understood that changes and modifications can be made therein in accordance with ordinary skill in the art without departing from the technology in its broader aspects as defined in the following claims.

The embodiments, illustratively described herein, may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, or compositions, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

1. A process for performing amidation of polyolefins comprising:
reacting a polyolefin, a copper catalyst, a functional group, a ligand, and an oxidant.

2. The process of claim 1, wherein the functional group comprises an amide, a carbamate, a sulfonamide, or an imide.

3. The process of claim 1, wherein the oxidant comprises a peroxide.

4. The process of claim 1, wherein the ligand is a compound of Formula I 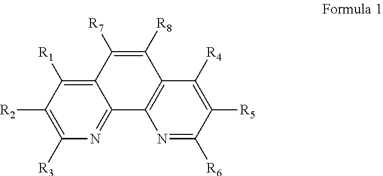
wherein,
R₁ and R₄ are each independently, H, a C₁ to C₄ alkyl group, a halide, a C₁ to C₄ alkoxide group or a C₁ to C₄ dialkylamino group;
R₂ and R₅ are each independently, H, a C₁ to C₈ alkyl group, a halide, a C₁ to C₈ alkoxide group, a C₁ to C₈ dialkylamino group or a trialkylsilyl group; and
R₃ and R₆ are each independently, H, a C₁ to C₈ alkyl group, a halide, a C₁ to C₈ alkoxide group or a C₁ to C₈ dialkylamino group,
R₇ and R₈ are each independently, H, or a C₁ to C₄ alkyl group, wherein the halide may be chloride, bromine or flouride.

5. The process of claim 4, wherein R₁ and R₄ are H, R₂ and R₅ are a C₁ alkyl group and R₃, R₆, R₇, and R₈ are H.

6. The process of claim 4, wherein R₁ and R₄ are H, R₂ and R₅ are a C₄ alkyl group and R₃, R₆, R₇, and R₈ are H.

7. The process of claim 4, wherein R₁ and R₄ are H, R₂ and R₅ are a C₈ alkyl group and R₃, R₆, R₇, and R₈ are H.

8. The process of claim 1, wherein the functional group is a compound of Formulae II to VII 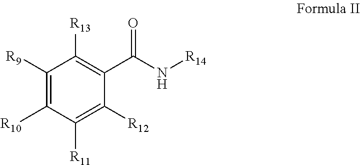
wherein R₉, R₁₀, R₁₁, R₁₂, and R₁₃are each independently H, a C₁ to C₄ alkyl group, a C₁ to C₄ alkyl ester group, t-butyldimethylsiloxy (TBSO), a nitrile (NC—), a halide, a C₁ to C₄ alkoxide group, or a C₁ to C₄ dialkyl amine, wherein the halide may include chlorine, fluorine or bromide, and R₁₄ is a H, or C₁ to C₄ alkyl benzamide; 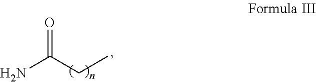
wherein, n=0 to 14;

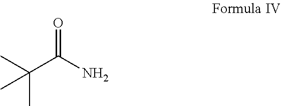

9.-11. (canceled)

12. The process of claim 1, wherein the polyolefin comprises polyethylene.

13.-18. (canceled)

19. The process of claim 1, wherein the reacting occurs at a temperature from about 80° C. to about 120° C.

20. (canceled)

21. The process of claim 1, wherein a degree of amide incorporation in the polyolefin is about 0.01 mol % to about 4.75 mol % based on monomer units.

22.-25. (canceled)

26. A composition comprising a copper catalyst, a functional group, an oxidant, and a ligand, wherein the composition includes the copper catalyst and the ligand in a 1:1 ratio.

27. The composition of claim 26, wherein the functional group comprises an amide, a carbamate, a sulfonamide, or an imide.

28. The composition of claim 26, wherein the oxidant comprises a peroxide.

29. (canceled)

30. (canceled)

31. The composition of claim 26, wherein the oxidant is included in an amount of 1 mol % to about 20 mol %.

32. The composition of clam 26, wherein the ligand is a compound of Formula I 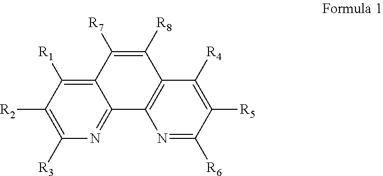
wherein,
R₁ and R₄ are each independently, H, a C₁ to C₄ alkyl group, a halide, a C₁ to C₄ alkoxide group or a C₁ to C₄ dialkylamino group;
R₂ and R₅ are each independently, H, a C₁ to C₈ alkyl group, a halide, a C₁ to C₈ alkoxide group, a C₁ to C₈ dialkylamino group or a trialkylsilyl group; and
R₃ and R₆ are each independently, H, a C₁ to C₈ alkyl group, a halide, a C₁ to C₈ alkoxide group or a C₁ to C₈ dialkylamino group,
R₇ and R₈ are each independently, H, or a C₁ to C₄ alkyl group, wherein the halide may be chloride, bromine or flouride.

33.-35. (canceled)

36. The composition of claim 26, wherein the functional group is a compound of Formulae II to VII 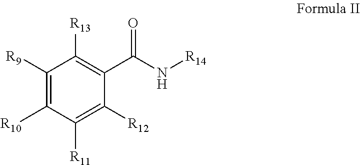
wherein R₉, R₁₀, R₁₁, R₁₂, and R₁₃ are each independently H, a C₁ to C₄ alkyl group, a C₁ to C₄ alkyl ester group, t-butyldimethylsiloxy (TBSO), a nitrile (C-triple bond N), a halide, or a C₁ to C₄ alkoxide group, wherein the halide may include chlorine, fluorine or bromide, and R₁₄ is H or a C₁ to C₄ alkyl benzamide; 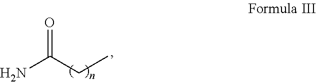
wherein, n=0 to 14;

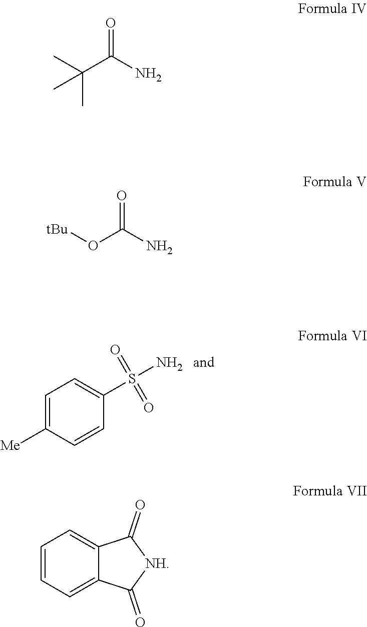

37.-40. (canceled)

41. The composition of claim 26, wherein the copper catalyst is included in an amount of about 0.1 mol % to about 1 mol %.

42. The composition of claim 26, wherein the ligand is included in an amount of about 0.1 mol % to about 1 mol %.

43. The composition of claim 26, wherein the amide is included in an amount of about 0.5 mol % to about 10 mol %.
